(19) United States
(12) Patent Application Publication
(10) Pub. No.: US 2002/0084917 A1
(43) Pub. Date: Jul. 4, 2002

(54) Method and apparatus for reducing traffic congestion

(76) Inventors: Benjamin J. Hauptman, Fairfax, VA (US); Ariel Hauptman, Fairfax, VA (US)

Correspondence Address: LOWE HAUPTMAN GILMAN & BERNER, LLP, 1700 Diagonal Road, Suite 310, Alexandria, VA, 22314, US

(21) Appl. No.: 09/749,434

(22) Filed: Dec. 28, 2000

(51) Int. Cl. G08G 1/04

(52) U.S. Cl. 340/937; 340/942

(57) ABSTRACT

A method and system for reducing traffic congestion is disclosed, wherein a video camera is used to scan license tags of vehicles transiting a particular roadway, preferably only during a time interval T2 during which it is desirable to use the motorway in order to alleviate congestion at another time T1. The scanned images are transmitted to a database to identify the vehicle owner. An appropriate reward may then be rewarded, such as a tax credit, to reward the motorist's behavior.

### TECHNICAL FIELD

The present invention relates generally to reducing traffic congestion and, more particularly, to the use of behavior modification through the use of rewards for reducing automotive vehicular traffic congestion.

### BACKGROUND ART

Automotive vehicular traffic congestion is a worldwide problem in most urban environments as well as other areas, such as tourist locales. To minimize congestion, municipalities budget and spend literally billions of dollars annually to add, extend, or widen highways and roads. This is an expensive effort to solve a problem that requires the use of taxpayer's money.

In addition, the use of HOV (High Occupancy Vehicle) lanes is popular, in which, during predetermined rush hour periods, only those vehicles that carry a predetermined minimum number of passengers may use these reserved lanes. If a vehicle driver carries fewer passengers, they are subject to receiving a traffic citation for committing a moving violation. Such tickets almost always involve a stiff fine as well as points that appear on the driver's record. A certain number of points can cause the driver to lose their automotive insurance protection and/or their driver's license.

Another approach that has been tried in order to reduce traffic congestion involves the use of permitting cars to travel only on certain days based on their license tag number. For example, vehicles ending in an odd number may only be operated on Mondays and Wednesdays while vehicles ending in an even number can only operate on Tuesdays and Thursdays. This method has been tried, for example, in Seoul, Korea, but was discontinued as a result of enforcement problems.

To be successful, the foregoing as well as other congestion reduction approaches of which we are aware require the use of law enforcement personnel to monitor for adherence to traffic regulations. This detracts from other crime fighting initiatives and increases taxpayer expenditures by requiring additional law enforcement personnel. Criminalizing traffic penalties also creates embarrassment on the part of offenders, not to mention characterization of certain types of behavior as criminal acts by persons who are otherwise law-abiding citizens.

It is accordingly an object of the present invention to minimize traffic congestion.

Another object is to minimize congestion without the use of law enforcement personnel.

Still another object is to minimize congestion without expensive roadway congestion.

Yet another object is to minimize congestion without the use of ticketing and penalties that punish illegal behavior.

Another object is to use positive reinforcement or a rewards based system that rewards drivers for behavior that contributes to reductions in traffic congestion.

### DISCLOSURE OF THE INVENTION

The present invention is directed to a method of reducing traffic congestion that comprises the steps of specifying one or more time based standards that encourages a motorist to use a certain motorway at a particular time of the day that is characteristic of reduced traffic congestion. The motorway is monitored with a sensor that can be used to identify the presence of the motorist on the motorway at the particular time. In this manner, the motorist can be rewarded for behavior that promotes reduced traffic congestion.

In one preferred embodiment, the sensor is a video camera that is strategically placed along the motorway to scan for information representative of a vehicles license tag. Indeed, such video cameras are already in use in certain municipalities where photographs are taken of a vehicular license tag as the vehicle illegally passes through a red traffic light. Alternatively, the videocam may be of a type already in use in certain locales for scanning motorways for sensing traffic conditions. A bar code scanning system may also be used in which a unique bar code is affixed to the motorist's vehicle to be scanned by a bar code scanner located along the motorway. The technology for identifying the vehicle already exists and may be adapted for use in the present invention with little or no change. Indeed, if desired, personnel may also be used to identify the motor vehicles.

Information representative of license tag information may be transmitted, using telephony, wireless or hard wired systems, to a database that correlates license tag information with the identity of the vehicle owner. In one preferred embodiment of this invention, this data base already exists as a compilation of all vehicular information maintained by state operated Departments of Motor Vehicles.

Once the vehicle owner is identified, an appropriate reward may then be given to the owner as a reward for using the motorway during, for example, a non-peak traffic period. The reward may take many different forms, e.g. legal tender, credits that maybe transferred by the state or municipality to the vehicle owner's credit card. It is also contemplated that the state may reward tax credits that may be dispensed by the appropriate tax bureau or agency where the motorist resides.

In the preferred embodiment, the invention is a completely computer based system that is entirely automated and therefore utilizes the above mentioned components and links in steps that do not involve human intervention except for the development or updating of software to identify or update the time based standards. With this invention, the motorist is advantageously encouraged to use certain motorways, or alternate routes identified by the appropriate traffic control authority, in a manner that reduces traffic congestion, through this unique form of behavior modification that rewards, but does not punish.

From the description of the invention herein, persons skilled in this art will be enabled to practice the invention in various forms without departing from the scope of the invention as defined by the claims below.

### BRIEF DESCRIPTION OF THE DRAWING

FIG. 1 is a block diagram of a preferred embodiment of this invention.

### BEST MODE FOR CARRYING OUT THE INVENTION

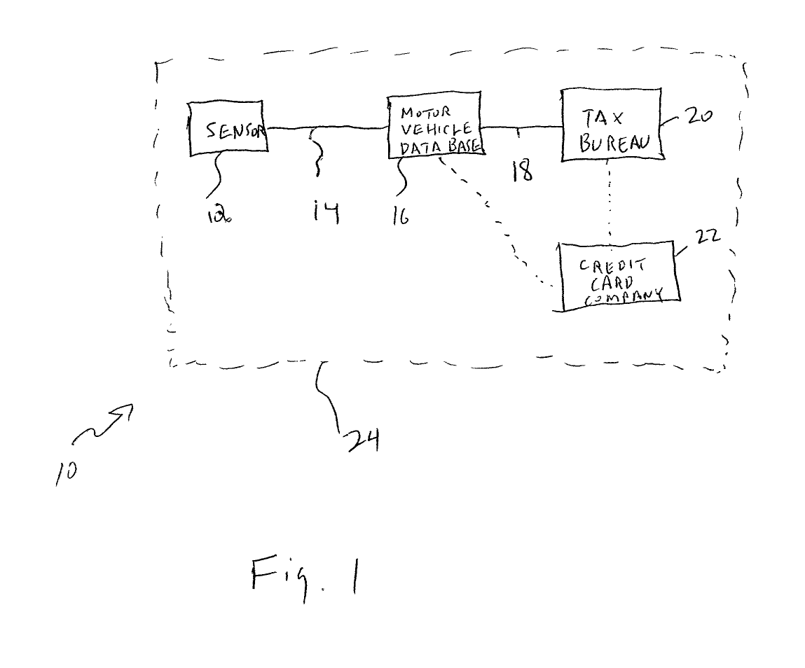

FIG. 1 is an illustration of a system 10 that embodies the principles of the present invention and contains a description that is more than sufficient to enable persons of ordinary skill in the relevant arts to practice this invention without undue experimentation.

System 10 begins with a preferably road based sensor 12 that is positioned along a designated motorway, in which it is desired to control traffic flow, for identifying vehicles on the motorway. Sensor 12 may be a video camera positioned to ‘see’ the vehicle license tag. Alternatively, sensor 12 may be a bar code scanning system. It is also conceivable that sensor 12 may be a satellite based system with sufficient resolution to identify a vehicle tag (or some other unique identifier) from an orbital position, and locate the vehicle position by means of GPS (Global Positioning System) technology.

Once a license tag is scanned with sensor 12, an information signal (e.g. digital) is transmitted via a transmission link 14 to a data base 16 containing records that correlates the vehicle tag with the identity of the vehicle owner. Transmission link 14 may be a hard wired system, a wireless or wired telephone line, or some other form of communication link known to persons skilled in the art. Upon receipt of the transmission signal, the appropriate record is accessed to identify the vehicle owner.

Once the vehicle owner is identified in the above manner with database 16, this information may be transmitted with another known transmission link 18 to the tax bureau 20 where the vehicle owner files tax returns. This information can be used to record, and award, a tax credit or deduction that the vehicle owner may use when preparing their tax return. In addition, or in the alternative, a cash payment or a cash credit or coupon may be sent by the tax bureau 20, a credit card company 22, or some other public or private agency, to reward the vehicle owner for allowing their vehicle to be operated in a manner conducive for minimizing traffic congestion on particular roadways.

In the preferred embodiment, system 10 is controlled with an appropriate software package and operating system(s), generally designated with reference numeral 24, that enables the traffic control authority to identify certain traffic locations L1 (i.e. motorway stretches) that are likely to become congested at certain times or time intervals T1 during the day, and thereby, other times T2 during the day when travel would minimize or alleviate congestion that would occur during T1. If a vehicle is identified with sensor 12 as traversing a traffic location L1 during T2, then this information (which maybe determined prior to accessing database 16 or after such access occurs) could generate the reward signal that would then be transmitted to 20 or 22 to create the reward. As travel demands change over time, the software can be appropriately modified to reflect changed conditions without necessitating hardware requirements.

The invention is defined by the claims below.

1. A method for reducing traffic congestion, comprising the steps of:
a) specifying one or more time based standards that encourages a motorist to use a certain motorway L1 at a particular time T2 of the day that will alleviate congestion at another time T1;
b) monitoring said motorway with a sensor;
c) identifying with said sensor the presence of the motorist on said motorway at said particular time T2; and
d) rewarding said motorist for using said motorway at said particular time.

2. The method of claim 1, wherein monitoring occurs with a video camera.

3. The method of claim 1, wherein monitoring occurs with a bar code scanning system in which a unique bar code is affixed to the motorist's vehicle to be scanned by a bar code scanner located along the motorway.

4. The method of claim 1, wherein a vehicle's license tag is scanned to identify the vehicle owner.

5. The method of claim 4, wherein the license tag information is digitized and transmitted to a government approved database that correlates the license tag information with the identity of the vehicle owner.
